(19) United States
(12) Patent Application Publication
(10) Pub. No.: US 2009/0016718 A1
(43) Pub. Date: Jan. 15, 2009

(54) WIRELESS DISTRIBUTION OF PASSIVE OPTICAL NETWORK SIGNALS

(75) Inventors: Michael Lorre Lubin, New York, NY (US); Mark J. Vanderaar, Medina, OH (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/170,644

(22) Filed: Jul. 10, 2008

Related U.S. Application Data
(60) Provisional application No. 60/948,938, filed on Jul. 10, 2007.

(51) Int. Cl. H04B 10/20

(52) U.S. Cl. 398/58; 398/118

(57) ABSTRACT

Systems, methods, and software are described for wirelessly distributing data from a Passive Optical Network (PON). The system includes a PON for transmitting an optical signal. The system further includes a distribution terminal coupled with the PON. The distribution terminal is to receive the optical signal, convert the optical signal to a set of data, and transmit the set of data via a wireless signal. The system further includes a first customer endpoint in communication with the distribution terminal. The first customer endpoint is to receive the wireless signal, demodulate and process a first subset of the set of data from the wireless signal, and then forward a second subset of the set of data via a second wireless signal. The system includes additional customer endpoints in communication with the first customer endpoint. The additional customer endpoints are configured to receive the second wireless signal and process the second subset.

### PRIORITY CLAIM

This application claims priority to U.S. Provisional Patent Application No. 60/948,938, entitled WIRELESS DISTRIBUTION OF PASSIVE OPTICAL NETWORK SIGNALS, filed on Jul. 10, 2007, which is incorporated by reference in its entirety for any purpose.

### BACKGROUND

The present invention relates to communications in general and, in particular, to wireless distribution of communication signals.

In certain passive optical network (PON) systems in order to serve residential or commercial areas a fiber strand is installed to each endpoint (e.g., residence or customer). In certain circumstances, obstructions, distance, etc. may make it inconvenient or expensive to trench this last connecting fiber. It may be desirable to have novel distribution techniques to avoid issues associated with connecting each endpoint with its own fiber.

### SUMMARY

Systems, devices, methods, and software are described for wirelessly distributing data from a Passive Optical Network (PON). In one embodiment, the system includes a PON for transmitting an optical signal. The system further includes a distribution terminal coupled with the PON. The distribution terminal is to receive the optical signal, convert the optical signal to a set of data, and transmit the set of data via a wireless signal. The system further includes a first customer endpoint in communication with the distribution terminal. The first customer endpoint is to receive the wireless signal, demodulate and process a first subset of the set of data from the wireless signal, and then forward a second subset of the set of data via a second wireless signal. The system includes additional customer endpoints in communication with the first customer endpoint. The additional customer endpoints are each configured to receive the second wireless signal and process the second subset.

In another embodiment, a method for wirelessly distributing data from a PON is described. The method includes receiving, at a distribution terminal, an optical signal from the PON. The method further includes transmitting the optical signal to a first customer endpoint via an optical transmission medium. The first customer endpoint is designated as a first base distribution point. The method then converts a set of data from the optical signal to a wireless signal at the first customer endpoint and wirelessly transmits the set of data using the wireless signal from the first customer endpoint to a second customer endpoint.

In an alternative embodiment, a method for wirelessly distributing data from a PON is described. The method includes receiving, at a distribution terminal, the optical signal from the PON. The method further includes converting a set of data from the optical signal to a wireless signal at the distribution terminal and wirelessly transmitting the wireless signal to a first customer endpoint. The method further includes wirelessly transmitting the wireless signal from the first customer endpoint to a second customer endpoint.

In a further embodiment, a system for wirelessly distributing data from a PON is described. The system includes a converter unit at a first customer endpoint configured to receive an optical signal for a second customer endpoint from a passive optical network and convert a set of data from the optical signal into a wireless signal. The system further includes a transmitter unit at the first customer endpoint which is communicatively coupled with the converter unit and configured to wirelessly transmit the converted signal to the second customer endpoint. The system further includes a receiver unit at the second customer endpoint which is configured to wirelessly receive the transmitted signal and process the signal.

In yet another embodiment, a machine-readable medium is described. The machine readable medium includes sets of instructions which, when executed by a machine, cause the machine to receive an optical signal from a PON, transmit the optical signal to a first customer endpoint via an optical transmission medium, convert a set of data from the optical signal to a wireless signal at the first customer endpoint, and wirelessly transmit the set of data within the wireless signal from the first customer endpoint to a second customer endpoint.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system for wirelessly distributing data from a Passive Optical Network (PON) according to various embodiments of the invention.

FIG. 2 is a block diagram of a system for wirelessly distributing data from a PON according to further embodiments of the invention.

FIG. 3 is a block diagram of a system for wirelessly distributing data from a PON to a mesh network according to various embodiments of the invention.

FIG. 4 is a block diagram of a distribution terminal for wirelessly distributing data from a PON according to various embodiments of the invention.

FIG. 5 is a block diagram of a customer endpoint for wirelessly distributing data from a PON according to various embodiments of the invention.

FIG. 6 is a flow diagram of a method of wirelessly distributing data from a PON according to various embodiments of the invention.

FIG. 7 is a flow diagram of a method for wirelessly distributing data from a PON according to various embodiments of the invention.

FIG. 8 is a flow diagram of a method of providing redundancy for wirelessly distributing data from a PON according to various embodiments of the invention.

### DETAILED DESCRIPTION OF THE INVENTION

The following description provides example embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments, the methods may be performed in an order different than that described and that various steps may be added, omitted or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

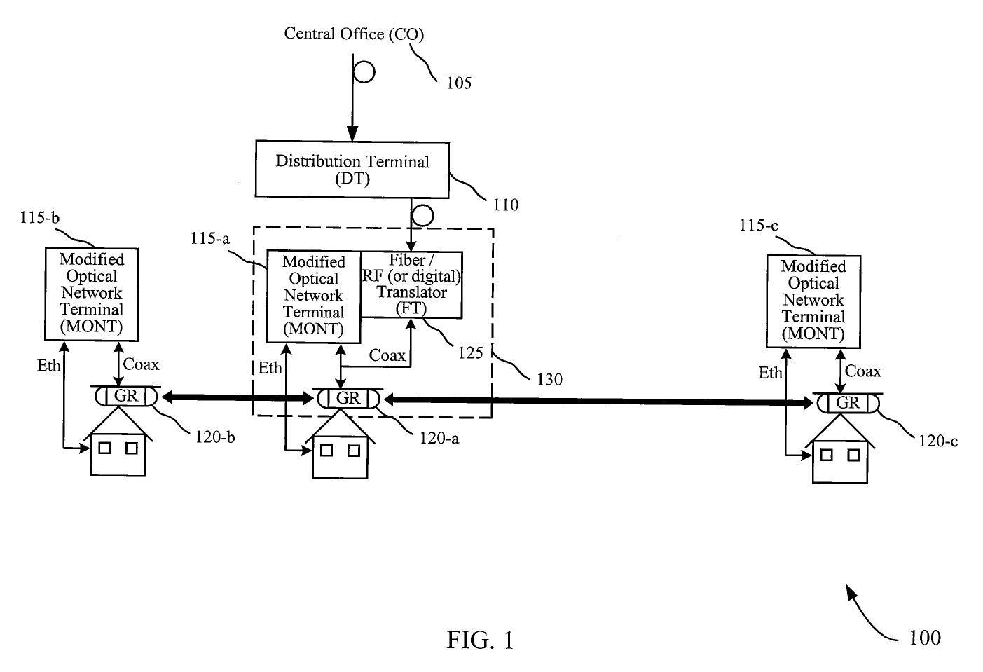

Referring to FIG. 1, a block diagram 100 illustrates a PON system that distributes data from the Central Office (CO) 105 to a Distribution Terminal (DT) 110. Although the data is shown coming from a CO 105, in other embodiments, the PON may be connected to other sources (e.g., a cable headend, or other source). The DT 110 may be a passive optical splitter/combiner that is placed close to the optical fiber running from the CO 105. For example, the DT 110 may be mounted on a telephone pole if the fiber is run above ground or on a pedestal if the fiber is underground. Other types of splitter/combiners are possible in other embodiments. The DT 110 may be a passive device that does not require DC power.

As noted above, in traditional implementations, fibers are often trenched from a passive DT 110 to an Optical Network Terminal (ONT) at the customer endpoint, often a residence. This ONT may be powered by household current and perform the modem and Medium Access Control (MAC) functions to convert the optical signal into Ethernet signals for use within the home network. The distance between the DT and ONT may be on the order of 10s to 100s of meters. To avoid the costs of trenching, wireless communications from the DT 110 may at first appear to be good option, but the cost to power a DT 110 and line of sight requirements may limit such implementations.

In the topology set forth in FIG. 1, one (or more) fiber(s) are installed to a base device or set of devices 130 at an endpoint (e.g., a convenient residence) or at another location with accessible power. However, instead of (or in addition to) connecting to an ONT, this fiber connects to a Fiber Translator (FT) 125. The FT converts the optical signals to electrical signals (either RF or digital).

At this base device or set of devices 130, these electrical signals from the FT 125 may connect at two places. First, the electrical signal connects to a Modified Optical Network Terminal (MONT) 115-a. The MONT 115-a is similar to an ONT, performing certain MAC functions, except the physical layer interface is electrical instead of optical. Second, the electrical signal may connect to a device called a Gigabit Repeater (GR) 120-a that is installed on the roof or some other convenient place on the residence. The same electrical wire (or coax) that carries the electrical signal may also carry DC power to supply the GR 120-a. Other schemes may power the GR 120-a as well (e.g., another electrical line from a residence). A variety of configurations may be used for the GR 120-a.

The GR 120-a may operate at a specified high RF frequency. The frequency may, for example, be selected based on convenience from a licensing, antenna size, and/or propagation perspective. The frequency may be set high enough that a lens antenna of less than 10 cm may be used. In one embodiment, the GR 120-a is used to distribute the electrical signal (that contains the same data as the fiber) in a point-to-point fashion. The GR 120-a may repeat a signal in two directions. In other embodiments, a number of directional or omnidirectional antenna configurations may be used (e.g., a Star topology). If so, a variety of multiplexing and/or addressing schemes may be used to share the base 130 among a number of endpoints. Moreover, while a GR 120 may look two directions, it could also look just one (e.g., if it is at “the end of the line”).

Regardless of the particular implementation, the repeated GR 120-a signal may then be wirelessly transmitted to one (or more) adjacent GRs 120-b that may be placed on the “next” location (e.g., a neighbor next door or other line of sight location). That GR 120-b may also distribute the signal to that customer's MONT 115-b. In this manner the signal can be conveniently distributed among customer premises (e.g., MONT 115-c, GR 120-c, etc.). There may be any number of instances of signal receptions and retransmissions between GRs 120, before a signal reaches the desired destination. For each GR 120, the signal transmitted therefrom may be a one-to-one, or one-to-many, transmission.

A number of variations on this topology are possible. For example, a hybrid approach wherein some of the final links are trenched or hung fiber and some are wireless is possible. Also, a GR 120 may be used to feed a powered DT 110 (perhaps at a customer residence) and the signal could be translated to the optical domain and again distributed by fiber. A similar application may use a GR 120 to bridge a link if the “backbone fiber” (e.g., one from the CO 105), is not close to any endpoint.

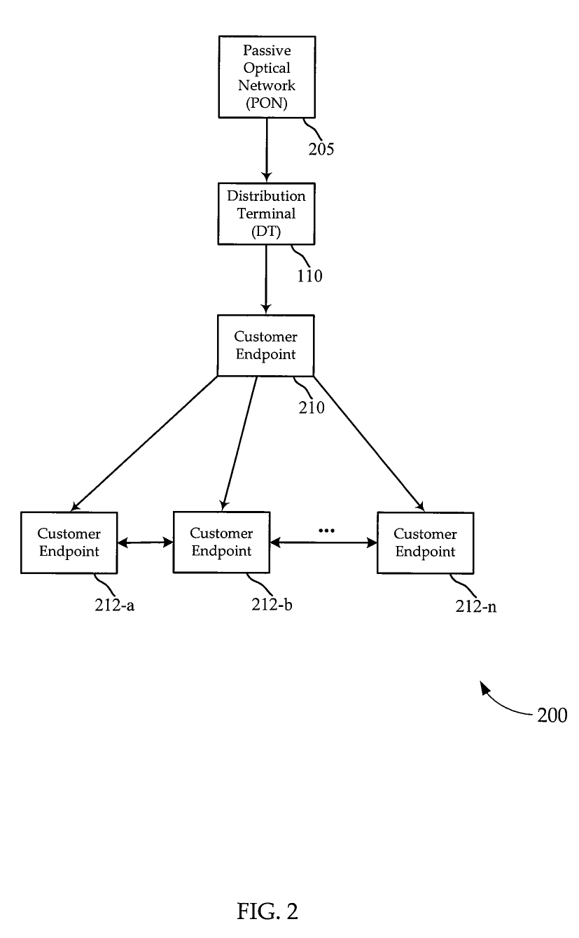

Referring now to FIG. 2, which illustrates a system 200 for wirelessly distributing data from a PON configured according to embodiments of the present invention. In one embodiment, system 200 includes a PON 205 which is configured to transmit an optical signal to the distribution terminal (DT) 110. The optical signal may be 1.5 to 2.0 gigabits/second (Gbps); however, other bandwidths may be used. Once the optical signal has been transmitted to the DT 110, the DT 110 is configured to forward the optical signal to individual customer locations.

In one embodiment, in order to avoid trenching fiber optic cable to each of the individual customer locations, DT 110 may be configured to first convert the optical signal into a set of data. The set of data may be stored in a memory buffer in a storage device within the DT 110. Further, the DT 110 converts the data stored within the memory buffer into a wireless signal. The wireless signal may then be transmitted to a customer endpoint 210. In one embodiment, the wireless signal may be a high frequency signal (e.g., 50 to 70 gigahertz (Ghtz)); however, other frequencies may be used.

In one embodiment, the customer endpoint 210 is designated as a base distribution point. A base distribution point may be, for example, a customer location which is designated as the entry point of the wireless signal for a collection of customer locations (i.e., customer endpoints 212-a, 212-b, to 212-n). Assume, merely for explanatory purposes, that the collection of customer locations is a residential community including four hundred homes. The expense of trenching fiber optic cable from the DT 110 to each of the homes would be too great making it impractical. Accordingly, in order to avoid such an expense and incontinence, a base distribution point within the residential community is selected to be the distribution channel of the PON signal for the rest of the homes within the community.

The customer location (or home) is selected based on its convenient access to the rest of the customer locations. For example, the customer endpoint 210 may be in a centralized or semi-centralized location within the community or may be on a hill or other such elevated point within the community. Alternatively, instead of a residential community, the collection of customer locations may be a business park, a strip mall, an office building, etc., and the customer endpoint 210 may be, for example, the location of a business within the office building.

In an alternative embodiment, instead of transmitting a wireless signal from the DT 110 to the customer endpoint 210, a fiber optic cable could be trenched to the customer endpoint 210. As such, only one customer location within the collection of customer locations would need a trenched cable. The cost would still be significantly less than trenching to each customer location within the collection of customer locations. Further, when selecting the customer endpoint 210, which is designated as the base distribution point, the simplest and least expensive trenching from the DT 110 to the customer location is ideal. For example, the base distribution point may be selected due to the fact that there is not a street or other obstruction between the customer location and the DT 110, or customer location is the shortest distance from the DT 110.

Accordingly, once the customer endpoint 210 has been designated as the base distribution point and has received the optical signal (either by a converted wireless signal or by a trenched optical cable), customer endpoint 210 is configured to distribute the signal to other customer endpoints 212-a, 212-b, to 212-n. Merely by way of example, there are only three customer endpoints 212-a, 212-b, to 212-n shown in FIG. 2; however, it should be understood that any number of customer endpoints 212 may be used. In one embodiment, thirty-two homes, businesses, buildings, etc. may be used.

In one embodiment, customer endpoint 210 may be configured to demodulate and process the wireless signal received from the DT 110. A processed set of data from the wireless signal may then be sub-divided into another set of data and wirelessly forwarded to the customer endpoints 212-a, 212-b, to 212-n. In one embodiment, each of the customer endpoints (including customer endpoint 210) is allocated a certain bandwidth allotment of the optical signal received from the PON 205. In one embodiment, each customer endpoint may be allocated 40 to 50 megabits/second (Mbps); nonetheless, other allotments may be used.

Accordingly, since customer endpoint 210 initially receives the entire bandwidth capacity of the optical signal from the DT 110, customer endpoint 210 would need to only keep its allotted portion of the signal's bandwidth and forward the rest to the other customer endpoints 212-a, 212-b, to 212-n. As such, even though customer endpoint 210 is receiving, for example, 1.5 to 2.0 Gbps of bandwidth capacity, customer endpoint 210 is only authorized to use its allotment (e.g., 50 Mbps). Hence, the remaining capacity is wirelessly forwarded to the other customer endpoints 212-a, 212-b, to 212-n.

In one embodiment, either the DT 110 or the customer endpoint 210 may determine the network topology of the customer endpoints within the collection of customer locations. Thus, based on the topology, a signal distribution configuration may be determined. The signal distribution configuration may be, for example, instructions for the customer endpoints within the collection of customer locations indicating how much bandwidth capacity, and to which customer endpoints to forward the signal, such that each of the customer endpoints receive their allotment of the optical signal's capacity.

For example, assuming that thirty-two customer endpoints are included in the collection of customer locations to be served by the PON 205's optical signal, that the optical signal has a bandwidth capacity of 2.0 Gbps, and that each of the customer endpoints are to receive 50 Mbps. The customer endpoint 210 initially received the entire 2.0 Gbps of bandwidth capacity and has, for example, sufficient line-of-sight (LOS) to five of the additional customer endpoints. Furthermore, based on the determined topology of the customer endpoints, one of the five customer endpoints with LOS to customer endpoint 210 has sufficient LOS to eight additional customer endpoints, whereas the other four customer endpoints only have sufficient LOS with four additional customer endpoints.

Accordingly, more bandwidth capacity would need to be forwarded to the first customer endpoint with LOS to eight additional customer endpoints than the other four customer endpoints with LOS to only four additional customer endpoints. Hence, the first customer endpoint would have an adequate amount of bandwidth capacity to ensure that the eight other customer endpoints will receive their full bandwidth allotment. Furthermore, the bandwidth allotment for each of the customer endpoints would be done in a recursive manner, such that each customer endpoint would be provided with a sufficient bandwidth allocation for use by the receiving customer endpoint aw well as enough to provide the other customer endpoints until all of the customer endpoints have received their designated bandwidth allotment.

In a further embodiment, considerations for failure, disconnection, termination, etc. of customer endpoints may be made. Alternate or secondary paths to each of the customer endpoints may be determined. For example, if customer endpoint A receives its allotment of bandwidth from customer endpoint B through customer endpoint C, and customer endpoint C fails, an alternate route from customer endpoint B to customer endpoint A would be needed. Accordingly, customer endpoint D may be selected to operate in the place of failed customer endpoint C.

Similar considerations may be made for changes to the terrain in and around the collection of customer locations. For example, a tree or building may be placed in the LOS between two customer endpoints causing a block in the LOS. Alternatively, a tree may be cute down or moved, thus providing LOS between customer endpoints which previously did not exist. Such changes would be taken into consideration when re-configuring the signal distribution.

Accordingly, the signal distribution configuration may be altered, updated, modified, etc. in order to accommodate for changes to the terrain, changes to the topology, failures of customer endpoints, etc. Additionally, such configurations may occur at the base distribution point, the DT 110, or may occur at each individual customer endpoint. In other words, each customer endpoint may be self-configuring. Nonetheless, the distribution configuration is dynamically maintained and updated in order to ensure that each customer endpoint is receiving its bandwidth allotment with as little interruption as possible. In a further embodiment, a committed information rate (CIR) may be established for some or all of the customer endpoints. The CIR is configured such that at any given time the bandwidth should not fall below a designated committed figure (e.g., 50 Mbps).

In a further embodiment, licensed as well as unlicensed frequency bands may be used to transmit the wireless signals. For example, the licensed frequency bands may be used for preferred customer endpoints or for customer endpoints which are distributing a signal to a greater number of customer endpoints. Furthermore, the unlicensed frequency bands may be used during peak usage times in order to increase wireless signal capacity. In addition, certain frequency bands which are better suited for certain climates and weather conditions may be used to accommodate such conditions. Additionally, coding for reducing multipath induced fading may be utilized to overcome certain environmental conditions within the collection of customer locations.

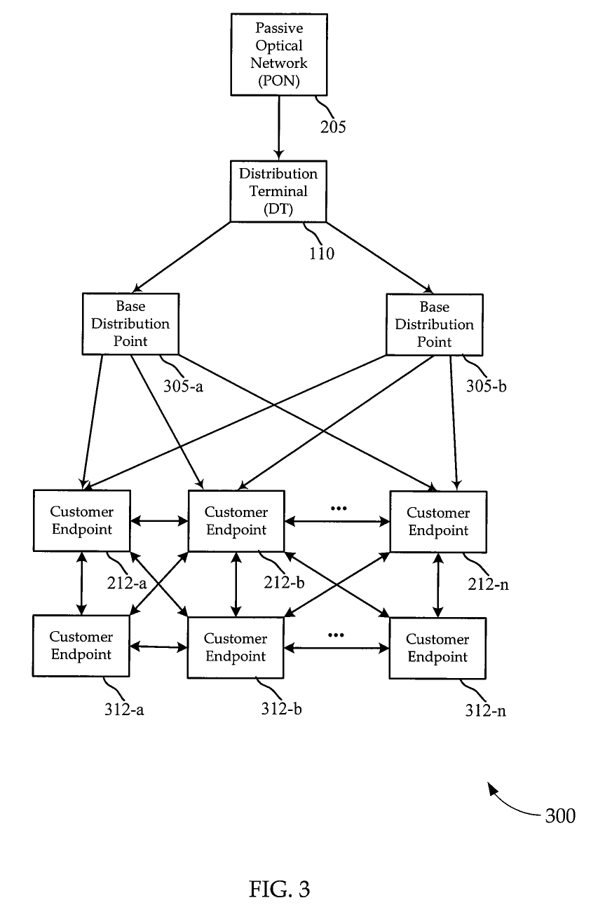

Referring next to FIG. 3, which illustrates a system 300 for wirelessly distributing data from a PON 205 to a mesh network configured according to embodiments of the present invention. In one embodiment, system 300 may include two base distribution points 305-a and 305-b. Nonetheless, additional base distribution points may be added, however, merely for purposes of explanation, only two base distribution points are shown. The base distribution points 305-a and 305-b be may both be connected to the DT 110 by fiber optic cables or, the base distribution points 305-a and 305-b may be wirelessly connected to the DT 110. Alternatively, one of the base distribution points 305-a or 305-b may be connected to the DT 110 by a fiber optic cable and one may be wirelessly connected. The base distribution points 305-a and 305-b are configured to function in the same or similar fashion as customer endpoint 210 in FIG. 2.

Furthermore, system 300 includes customer endpoints 212-a, 212-b, to 212-n and 312-a, 312-b, to 312-n coupled together in a mesh network configuration. As such, the mesh network configuration allows for all (or nearly all) of the nodes (i.e., customer endpoints) within a network to be interconnected. Thus, failures can be managed by utilizing an alternate node based on all nodes being interconnected. For example, if customer endpoint 312-b typically receives a wireless signal through customer endpoint 212-b, and customer endpoint 212-b fails, the signal can simply be re-routed through customer endpoint 212-a. Hence, redundancy among the customer endpoints can be seamlessly maintained.

Similarly, base distribution points 305-a and 305-b provide redundancy. In one embodiment, each of the base distribution points 305-a and 305-b function at half or less than half capacity in order to be able to handle the other base distribution point's distribution load in the event that one fails. Alternatively, only one of the base distribution points are active at any given point in time, and only become active in the event that the other base distribution point fails. Accordingly, complete failure to the customer endpoints within the collection of customer locations can be avoided or at least the likelihood can be significantly reduced.

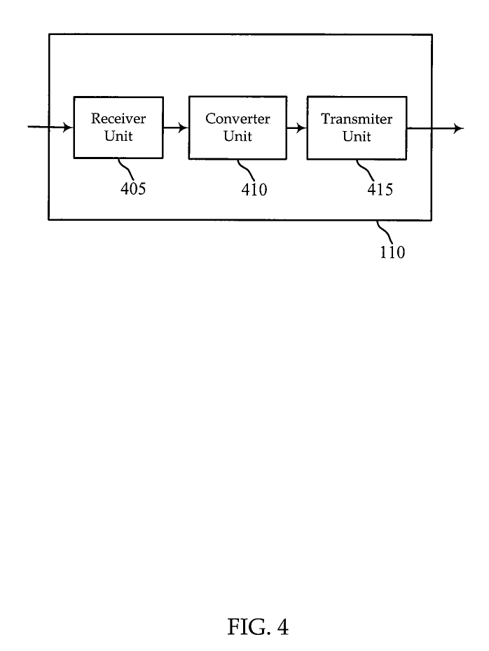

Turning now to FIG. 4, which illustrates a further embodiment of the DT 110. In one embodiment, DT 110 may include a receiver unit 405. The receiver unit 405 may be configured to receive, for example, the optical signal from the PON 205 (FIGS. 1-3). Furthermore, the receiver unit 405 may buffer data from the optical signal in a memory device (not shown) and forward the buffered data to a converter unit 410. Alternatively, the data from the optical signal may pass from the receiver unit 405 to the converter unit 410 without any buffering.

In one embodiment, converter unit 410 may be configured to convert the data received from the optical signal into a wireless signal. The wireless signal may then be forwarded to a transmitter unit 415. The transmitter unit 415 is then configured to transmit the wireless signal to, for example, customer endpoint 210 in FIG. 2. In an alternative embodiment, DT 110 may simply function as an optical signal repeater which receives the optical signal at receiver unit 405 from PON 205 (FIGS. 1-3) and forwards an optical signal to the customer endpoint 210 (FIG. 2) without converting the data from the optical signal into a wireless signal.

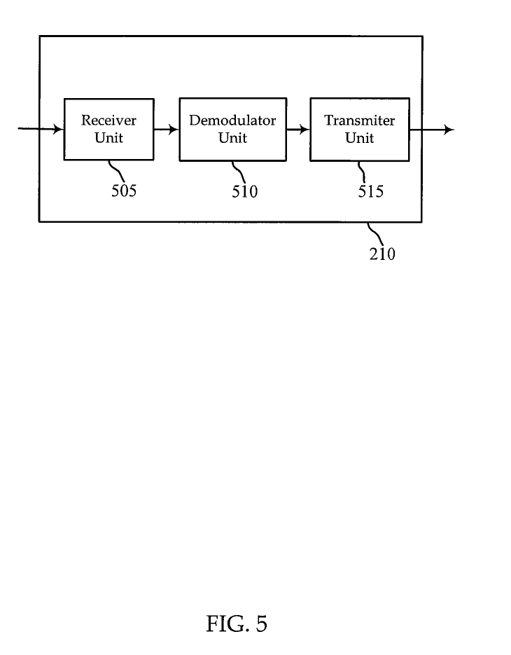

Turning next to FIG. 5, which illustrates a further embodiment of the customer endpoint 210. Customer endpoint 210 may include a receiver unit 505. In one embodiment, the receiver unit 505 may be configured to receive the wireless signal transmitted by transmitter unit 415 in DT 110 (FIG. 4). Alternatively, in the event that the DT 110 (FIG. 4) is transmitting an optical signal, the receiver unit 505 would be configured to receive an optical signal instead of a wireless signal.

Once the receiver unit 505 receives the signal (either an optical signal or a wireless signal), the receiver unit 505 forwards the signal to a demodulator unit 510. In one embodiment, the demodulator unit 510 removes any modulation from the analog signal to have the original base-band signal remaining. Demodulating may be necessary because the receiver unit 505 receives a modulated signal with specific characteristics and the receiver unit 505 needs the signal to be converted back into the base-band format.

In a further embodiment, demodulator unit 510 may forward the demodulated signal to a transmitter unit 515. In one embodiment, the transmitter unit 515 is a high frequency wireless transmitter configured to transmit a portion of the received signal to additional customer endpoints within the network. In one embodiment, the transmitter unit 515 may utilize lenses in order to reduce the size of transmitter unit 515 are well as provide increased functionality in poor and/or adverse weather conditions (e.g., rain, snow, etc.).

In one embodiment, transmitter unit 515 may be powered by, for example, an Ethernet or other network connection to a computing system at the customer endpoint. For example, if the customer endpoint is a home or business, the power from an Ethernet connection to a personal computer, or the like could be used to power the transmitter unit 515. Alternatively, the public utilities from the home or office building may be used to power the transmitter unit 515. Furthermore, the same or similar receiver units 505 and transmitter units 515 may be placed on the additional customer endpoints within the network in order to receive wireless signals as well as send wireless signals. Additionally, the receiver unit 505 and the transmitter unit 515 may be placed on the roof or other sufficiently high location in order to maximize LOS.

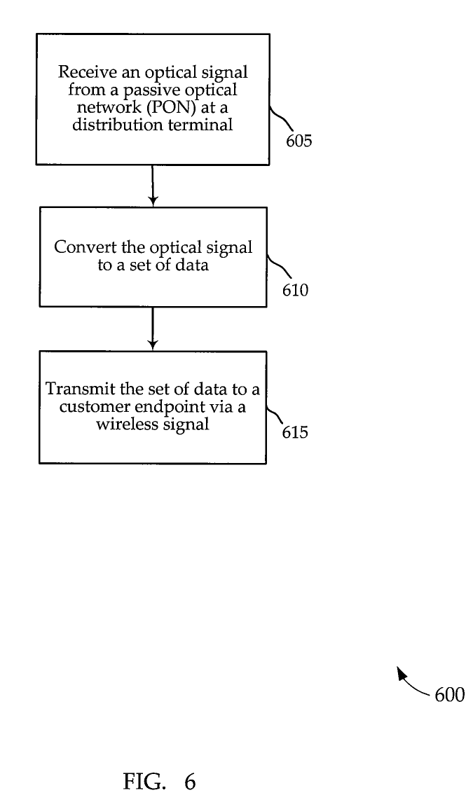

Referring to FIG. 6, which illustrates a method 600 for wirelessly distributing data from a PON 205 (FIG. 2) in accordance with embodiments of the present invention. At block 605, an optical signal is received from a PON 205 (FIG. 2) at a DT 110 (FIG. 2). At block 610, the optical signal is converted into a set of data and stored in a buffer. At block 615, the set of data is then transmitted to a customer endpoint 210 (FIG. 2) via a wireless signal. In one embodiment, the customer endpoint 210 (FIG. 2) is designated as a base distribution point for additional customer endpoints, as described above. Method 600 may be implemented using the systems described in any of FIG. 1, 2, or 3.

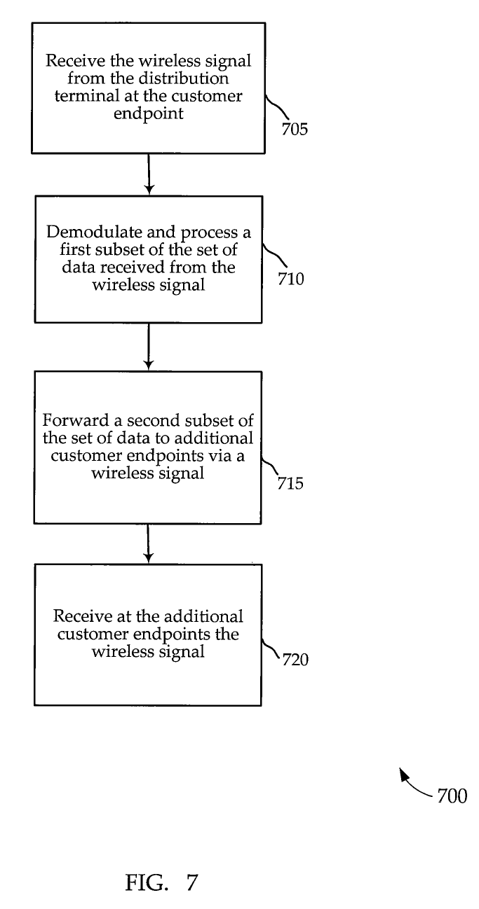

Turning to FIG. 7, which illustrates a method 700 for wirelessly distributing data from a PON 205 (FIG. 2) configured according to further embodiments of the present invention. At block 705, the wireless signal transmitted from the DT 110 (FIG. 2) to the customer endpoint 210 (FIG. 2) is received by the customer endpoint 210 (FIG. 2). At block 710, the received wireless signal is demodulated and processed into a first subset of the set of data. At block 715, a second subset of the set of data is forwarded to the additional customer endpoints. The second subset of the set of data may be utilized by the additional customer endpoints for further distribution to other customer endpoints or may be used by the receiving customer endpoint (block 720). Furthermore, method 700 may be implemented using the systems described in any of FIGS. 1-5.

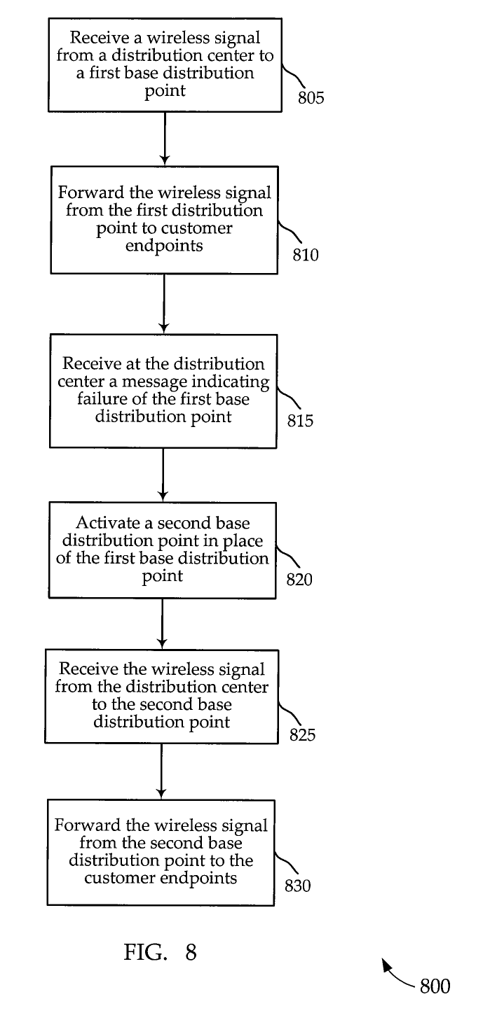

Referring now to FIG. 8, which illustrates a method 800 for providing redundancy for wirelessly distributing data from a PON 205 (FIG. 2) configured according to embodiments of the present invention. At block 805, a wireless signal is received from the DT 110 (FIG. 2) to a first base distribution point. The first base distribution point forwards a portion of the wireless signal to customer endpoints in accordance with FIGS. 1, 2, and/or 3 (block 810).

At block 815, a message indicating that the first base distribution point has failed is transmitted to the DT 110 (FIG. 2). At block 820, the DT 110 (FIG. 2) transmits a message to a second base distribution point instructing the second base distribution point to switch to active status. The second base distribution point is configured to provide redundancy for the first base distribution point. Hence, at block 825, the second base distribution point receives a wireless signal from the DT 110 (FIG. 2). Accordingly, at block 830, the wireless signal from the second base distribution point is forwarded to the additional customer endpoints. Further, method 800 may be implemented using the systems described in any of FIGS. 1-5.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figures.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for wirelessly distributing passive optical network (PON) signals within a distribution network, the system comprising:
a PON configured to transmit an optical signal;
a distribution terminal communicatively coupled with the PON, the distribution terminal configured to:
receive the optical signal;
convert the optical signal to a set of data; and
transmit the set of data via a wireless signal;
a first customer endpoint in communication with the distribution terminal, wherein the first customer endpoint is configured as a first base distribution point, the first customer endpoint configured to:
receive the wireless signal;
demodulate and process a first subset of the set of data from the received wireless signal; and
forward a second subset of the set of data via a second wireless signal; and
a plurality of additional customer endpoints in communication with the first customer endpoint, the plurality of customer endpoints each configured to receive the second wireless signal and process the second subset.

2. The system of claim 1, wherein the distribution terminal is further configured to transmit the optical signal to a second customer endpoint, wherein the second customer endpoint is designated as a second base distribution point.

3. The system of claim 2, wherein the second customer endpoint is configured to convert data from the optical signal to a wireless signal.

4. The system of claim 3, wherein the first base distribution point and the second base distribution point are configured to provide redundancy of service to each of the plurality of additional customer endpoints.

5. The system of claim 1, wherein the distribution terminal comprises a second customer endpoint.

6. The system of claim 1, wherein the optical signal comprises a bandwidth between 1.5 and 2.0 gigabits, and wherein the wirelessly transmitted wireless signal is transmitted at a frequency between 50 and 70 GHz.

7. The system of claim 6, wherein the transmitting of the wireless signal comprises transmitting using either licensed or unlicensed transmission frequencies.

8. The system of claim 7, wherein customer endpoints using licensed transmission frequencies are provided with a higher committed information rate (CIR) than customer endpoints using unlicensed transmission frequencies.

9. The system of claim 1, wherein the distribution network is configured as a mesh network.

10. The system of claim 9, wherein the mesh network is configured to, in response to failure of one or more of the plurality of additional customer endpoints, maintain connectivity between the plurality of additional customer endpoints.

11. The system of claim 1, wherein the distribution terminal and the first customer endpoint are coupled via an optical transmission medium, wherein the optical transmission medium comprises trenched fiber optic cable connecting the distribution terminal with the first customer endpoint.

12. A method of providing wireless network technologies for distribution of a passive optical network (PON) signal within a customer distribution network, the method comprising:
receiving, at a distribution terminal, the optical signal from the PON;
transmitting the optical signal to a first customer endpoint via an optical transmission medium, wherein the first customer endpoint is designated as a first base distribution point;
converting a set of data from the optical signal to a wireless signal at the first customer endpoint; and
wirelessly transmitting the set of data within the wireless signal from the first customer endpoint to a second customer endpoint.

13. The method of claim 12, further comprising:
prior to wirelessly transmitting the wireless signal to the second customer endpoint, storing the wireless signal in a first buffer at the first customer endpoint;
designating a first portion of the buffered wireless signal for use by the first customer endpoint; and
designating a second portion of the wireless signal for transmission to at least one of a first plurality of customer endpoints.

14. The method of claim 13, further comprising:
storing the second portion of the wireless signal in a second buffer;
designating the wireless signal into a plurality of sub-divided portions; and
wirelessly transmitting the designated plurality of sub-divided portions of the wireless signal to the first plurality of customer endpoints, wherein the first plurality of customer endpoints are configured to receive one of the designated sub-divided portions of the wireless signal.

15. The method of claim 14, wherein each of the first plurality of customer endpoints are configured to further designate the sub-divided portions of the wireless signal to be wirelessly transmitted to a second plurality of customer endpoints such that each of the customer endpoints within the customer distribution network are configured to receive a designated portion of the wireless signal.

16. The method of claim 15, wherein the customer endpoints are configured to determine a designation amount for the divided and sub-divided portions of the wireless signal.

17. The method of claim 15, further comprising installing, at each of the first and second pluralities of customer endpoints, radio receivers configured to receive the wirelessly transmitted designated portions of the wireless signal.

18. The method of claim 17, wherein the radio receivers include lenses configured to reduce the size of the radio receivers.

19. The method of claim 17, wherein the radio receivers receive power from either an Ethernet cable connected to a computing device located at each customer endpoint or from each customer endpoint's utility power source.

20. A system comprising:
a converter unit at a first customer endpoint configured to:
receive an optical signal for a second customer endpoint from a passive optical network (PON); and
convert a set of data from the optical signal into a wireless signal;
a transmitter unit at the first customer endpoint, communicatively coupled with the converter unit, and configured to wirelessly transmit the set of data within the converted signal to the second customer endpoint; and
a receiver unit at the second customer endpoint configured to:
wirelessly receive the transmitted signal; and
process the signal.

21. The system of claim 20, further comprising providing the transmitter unit with signal partitioning instructions.

22. The system of claim 20, wherein the wirelessly transmitting of the converted signal is encoded to account for signal fading.

23. A machine-readable medium having sets of instructions stored thereon which, when executed by a machine, cause the machine to:
receive an optical signal from a passive optical network (PON);
transmit the optical signal to a first customer endpoint via an optical transmission medium;
convert a set of data from the optical signal to an wireless signal at the first customer endpoint; and
wirelessly transmit the set of data within the wireless signal from the first customer endpoint to a second customer endpoint.
